(19) United States
(12) Patent Application Publication
(10) Pub. No.: US 2006/0082511 A1
(43) Pub. Date: Apr. 20, 2006

(54) Electronically controlled dual polarizer

(76) Inventor: Gordon D. Osterhues, Irvine, CA (US)

Correspondence Address: Greg J. Michelson;MacPHERSON KWOK CHEN & HEID LLP, 1762 Technology Drive, Suite 226, San Jose, CA, 95110, US

(21) Appl. No.: 10/951,569

(22) Filed: Sep. 27, 2004

(51) Int. Cl. H01Q 19/00

(52) U.S. Cl. 343/756; 343/909

(57) ABSTRACT

Systems and methods provide an electronically controlled polarizer for antenna applications. For example, in accordance with an embodiment of the present invention, an electronically controlled dual polarizer is disclosed, which may selectively allow horizontally or vertically polarized signals to pass through (e.g., during transmission and/or reception) or selectively provide right hand or left hand circular polarization to a linearly polarized signal.

### TECHNICAL FIELD

The present invention relates generally to antennas and, more particularly, to polarizers for antennas.

### BACKGROUND

Communication systems, including radar applications and other applications that require the transmission or reception of information, typically utilize one or more antennas to transmit and/or receive electromagnetic (EM) signals. There are many different types of antennas, with the specific type selected depending upon an application's requirements (e.g., coverage and frequency range).

As an example, for airborne radar applications (e.g., in the microwave or millimeter wave portion of the EM spectrum), mechanically scanned antennas (MSA) are commonly employed. An MSA generally includes a planar antenna array mounted on a gimbal subassembly designed to scan over a volume of space.

As an alternative to an MSA is an electronically scanned antenna (ESA). ESAs are often utilized for ground and shipboard radars and, with technological advances, are being introduced into airborne applications (e.g., aircraft, missiles, or small drones). An ESA may provide certain advantages over an MSA, such as, for example, a faster scan rate, fewer mechanical components (e.g., no gimbal assembly) or components that do not need to be flexed (e.g., flexible coaxial cables or other types of connectors), and may offer solid state reliability. The ESA may also provide greater system flexibility and may be easier to upgrade by reprogramming its electronic control circuitry.

Because an ESA is fixed and cannot be physically pointed in a desired direction like an MSA, there may be degradation in the rejection of cross-polarized signals (EM signals whose electric field is oriented orthogonal to the desired electric field), such as when the ESA is electronically scanning off boresight. The cross-polarized signals (or other types of spurious polarized signals) may raise the sidelobes at off-boresight scan angles, which may increase the angle noise level of the radar system. As a result, there is a need for a technique to reduce the level of these cross-polarized signals.

### SUMMARY

Systems and methods are disclosed herein to provide an electronically controlled polarizer for antenna applications. For example, in accordance with an embodiment of the present invention, an electronically controlled dual polarizer is disclosed. The electronically controlled dual polarizer may selectively allow horizontally or vertically polarized signals to pass through (e.g., during transmission and/or reception). The electronically controlled dual polarizer may also be implemented to provide right hand or left hand circular polarization to a linearly polarized signal.

More specifically, in accordance with one embodiment of the present invention, an antenna system includes an antenna adapted to receive or transmit electromagnetic signals; a first plurality of line segments arranged in a first plane, wherein the electromagnetic signals pass through the first plurality of line segments traveling to or from the antenna; and a first plurality of switches adapted to couple the first plurality of line segments into rows on the first plane when the first plurality of switches is closed.

In accordance with another embodiment of the present invention, a system includes an antenna; a number of line segments arranged in a first and a second plane, which electromagnetic signals pass through when traveling to or from the antenna; and a number of switches adapted to link the line segments to form a number of rows on the first and second plane.

In accordance with another embodiment of the present invention, a method of selectively rejecting signals being received by or transmitted from an antenna includes connecting a first plurality of line segments to form a number of first rows to reflect signals having a first polarization while allowing signals to pass through having a second polarization; and connecting a second plurality of line segments to form a number of second rows to reflect signals having the second polarization while allowing signals to pass through having the first polarization.

In accordance with another embodiment of the present invention, a method of providing circular polarization to a linearly polarized signal includes connecting a first plurality of line segments to form a number of first rows in a first and a second dual polarizer, wherein the linearly polarized signal is transformed into a right hand circularly polarized signal when the linearly polarized signal passes through the first and second dual polarizers; and connecting a second plurality of line segments to form a number of second rows in the first and second dual polarizers, wherein the linearly polarized signal is transformed into a left hand circularly polarized signal when the linearly polarized signal passes through the first and second dual polarizers.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1a shows a diagram illustrating a polarizer in accordance with an embodiment of the present invention.

FIG. 1b shows a diagram illustrating another polarizer in accordance with an embodiment of the present invention.

FIG. 2 shows a diagram illustrating a dual polarizer combining the polarizers of FIGS. 1a and 1b in accordance with an embodiment of the present invention.

FIG. 3 shows a diagram illustrating an antenna having the dual polarizer combining the polarizers of FIGS. 1a and 1b in accordance with an embodiment of the present invention.

FIG. 4 shows a diagram illustrating a dual polarizer combining the polarizers of FIGS. 1a and 1b in accordance with an embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

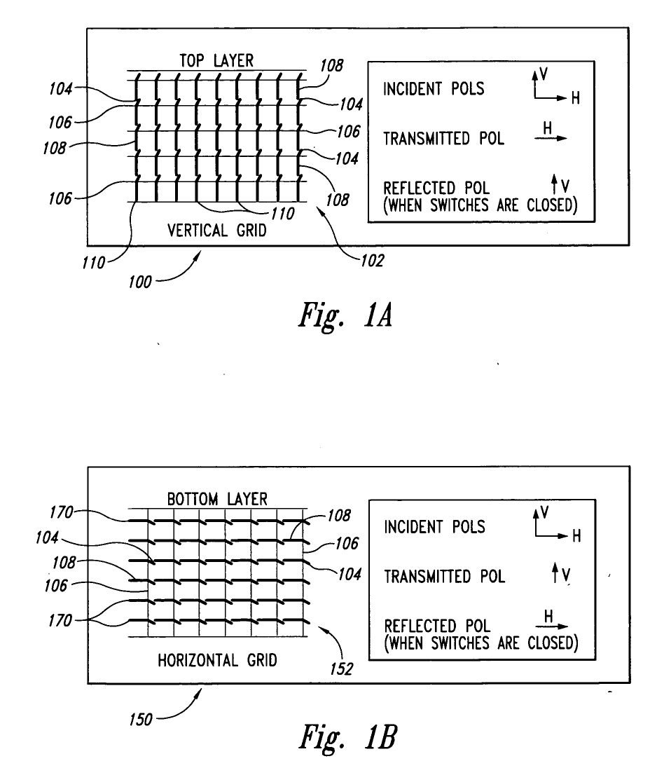

FIG. 1a shows a diagram 100 illustrating a portion of a polarizer 102 in accordance with an embodiment of the present invention. Polarizer 102 includes switches 104, control signal leads 106, and line segments 108.

Line segments 108 are arranged in columns 110, with line segments 108 within each column 110 selectively coupled by switches 104 to form a solid line (e.g., a solid wire line) in each column 110. Switches 104 are controlled by control signals via control signal leads 106. Control signal leads 106 may be made, for example, of a high impedance material to minimize transmission signal loss.

Control signal leads 106 may be routed, as desired. For example, FIG. 1a illustrates control signal leads 106 being rotated perpendicular to columns 110. However, this is not limiting and control signal leads 106 may be routed based upon the type of antenna or application and type of switch 104. As an example, control signal leads 106 may be routed along with (e.g., parallel to) line segments 108 to form columns (e.g., formed as part of columns 110).

Switches 104 may be any type of switch that may be implemented to connect line segments 108. For example, switches 104 may represent transistors, PIN diodes, or micro-electromechanical system (MEMS) switches that are controlled to selectively open or close the connection between line segments 108 based on control signals on control signal leads 106.

If PIN diodes are utilized for switches 104, control signal leads 106 may be simplified and, rather than being routed to each switch 104, may only be attached at each end of columns 110 (e.g., along a periphery of an antenna's aperture), which may also reduce the insertion loss. For example, because PIN diodes are a current controlled device, when a voltage is applied to the first PIN diode in each column 110, current flows through the PIN diode (i.e., the switch closes) and a voltage is applied to the next PIN diode. The next PIN diode begins to conduct current (i.e., the switch closes) and a voltage is applied to the following PIN diode in the series, with this sequence repeating until all of the PIN diodes (switches 104) in the column are closed.

In general, when switches 104 are open, electromagnetic (EM) signals pass through polarizer 102 regardless of the polarity of the EM signals. However, when switches 104 are closed, line segments 108 are joined together to form a grid of parallel, continuous lines in corresponding columns 110. As illustrated in FIG. 1a, when switches 104 are closed, EM signals that are vertically polarized (e.g., orientation of the electrical field parallel to the grid lines or columns 110) are reflected, while EM signals that are horizontally polarized (e.g., orientation of the electrical field perpendicular to the grid lines or columns 110) are allowed to pass through polarizer 102 (e.g., are transmitted). Note that the vectors may not be drawn to scale in the figures and are generally utilized to illustrate which polarities are reflected and transmitted.

FIG. 1b shows a diagram 150 illustrating a portion of a polarizer 152 in accordance with an embodiment of the present invention. Polarizer 152 is similar to polarizer 102 of FIG. 1a, but is orientated (e.g., rotated ninety degrees) so that columns 110 are now rows 170 (although it should be noted that the terminology rows and columns may be used interchangeably and simply denote that line segments 108 are arranged end-to-end in substantially parallel lines).

As with polarizer 102, when switches 104 are open, polarizer 152 allows EM signals to pass through (e.g., transmitted) regardless of the polarity of the EM signals. However, when switches 104 are closed, line segments 108 are joined together to form a grid of parallel, continuous lines in corresponding rows 170. As illustrated in FIG. 1b, when switches 104 are closed, EM signals that are horizontally polarized are reflected, while EM signals that are vertically polarized are allowed to pass through polarizer 152.

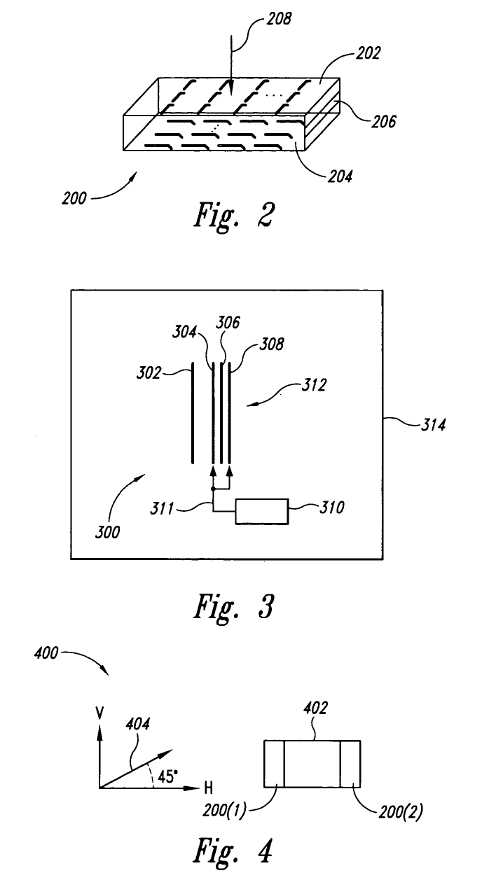

Polarizer 102 (FIG. 1a) may be combined with polarizer 152 (FIG. 1b) to provide a polarizer that may selectively block vertically and/or horizontally polarized signals (e.g., polarizer 102 forms a top layer and polarizer 152 forms a bottom layer of a dual polarizer). For example, FIG. 2 shows a diagram illustrating a portion of a polarizer 200 in accordance with an embodiment of the present invention.

Polarizer 200 (e.g., a dual polarizer) includes a polarizer 202 and a polarizer 204. One or more additional layers 206 may also optionally be included as part of polarizer 200. For example, layer 206 in FIG. 2 may represent a thin, stiff, low loss dielectric material that is placed between polarizer 202 and polarizer 204 to provide structural stability or a desired spacing between polarizers 202 and 204. Layer 206 may be disposed along the periphery or extend across polarizer 200 to be entirely between polarizers 202 and 204. Furthermore, layer 206 may or may not influence (e.g., provide a certain amount of phase shift to) any signal passing through layer 206, depending on the material selected and the desired application.

Polarizer 202 represents a layer of polarizer 200 and may be constructed in a similar fashion and orientated as described for polarizer 102 (FIG. 1a). Polarizer 204 represents a layer of polarizer 200 and may be constructed in a similar fashion and orientated as described for polarizer 152 (FIG. 1b). Consequently, polarizer 200 may represent an electronically controlled dual polarizer that can be controlled to block horizontally polarized EM signals, vertically polarized EM signals, or both horizontally and vertically polarized EM signals.

For example, if switches 104 of polarizers 202 and 204 are open, then no EM signals of a signal 208 are blocked and the EM signals pass through polarizer 200 regardless of their polarity. If switches 104 of polarizer 202 are closed and switches 104 of polarizer 204 are open, then vertically polarized EM signals are blocked while horizontally polarized EM signals of signal 208 pass through polarizer 200. If switches 104 of polarizer 202 are open and switches 104 of polarizer 204 are closed, then horizontally polarized EM signals are blocked while vertically polarized EM signals of signal 208 pass through polarizer 200. If switches 104 of polarizers 202 and 204 are closed, then horizontally polarized EM signals and vertically polarized EM signals are blocked.

As an example, in accordance with an embodiment of the present invention, polarizer 200 may be implemented as part of a communication system (e.g., a radar system). The communication system, for example, may be ground-based, ship-based, aircraft-based (e.g., an airplane, a missile, or an unmanned aerial vehicle (UAV)), or spacecraft-based system. In general, any system that utilizes an ESA may benefit from polarizer 200. Furthermore, for example, by controlling polarizers 202 and 204, as described herein, vertically or horizontally polarized signals may be selectively rejected to provide cross-polarization rejection (e.g., with minimal insertion loss to the desired polarized signal).

As an example, in accordance with an embodiment of the present invention, FIG. 3 shows a diagram illustrating an antenna system 300 having a polarizer 312 (e.g., a dual polarizer) in accordance with an embodiment of the present invention. Antenna system 300 includes an antenna 302, a polarizer 312, and a control system 310.

Antenna 302 represents any type of desired antenna (e.g., an electronically scanned antenna) for transmitting signals through polarizer 312 and/or receiving signals through polarizer 312. Polarizer 312 may be implemented similar to that of polarizer 200, with polarizers 304 and 308 orientated to selectively block horizontally and vertically polarized signals, respectively. An optional layer 306, which corresponds to layer 206 of polarizer 200, may also be included.

Control system 310 provides control signals via control signal leads 311 to control polarizers 304 and 308 (e.g., control switches 104). Control system 310, for example, represents a processor or other type of conventional controller that can provide the control signals to polarizers 304 and 308. Antenna system 300 may be contained within a structure 314, with structure 314 representing a ground-based structure, a ship-based structure, an aircraft, a spacecraft, or any type of structure requiring an antenna for receiving and/or transmitting EM signals.

In accordance with an embodiment of the present invention, right and/or left hand circular polarization may also be provided. For example, one polarizer 200 (FIG. 2) may be substituted for polarizer 304 and another polarizer 200 may be substituted for polarizer 308 in FIG. 3, with the pair of polarizers 200 orientated to provide right hand circular polarization or left hand circular polarization for a linearly polarized signal.

As another example, FIG. 4 shows a diagram illustrating a polarizer 400 (e.g., a dual circular polarizer) in accordance with an embodiment of the present invention. Polarizer 400 includes a pair of polarizers 200 (separately referenced as polarizers 200(1) and 200(2)), which are arranged to provide left and/or right hand circular polarization. Polarizers 200(1) and 200(2) may be separated by a certain distance, which for example may be set by a spacer 402 (e.g., similar to layer 206 of FIG. 2). Furthermore, additional layers of pairs of polarizers (i.e., additional pairs of polarizers 200 and optionally spacers 402) may be included in polarizer 400 to achieve a broader bandwidth.

Specifically, as indicated in FIG. 4, polarizers 200(1) and 200(2) are orientated 45 degrees relative to a linearly polarized signal 404. Thus, by closing switches 104 of the vertical grids of polarizers 200(1) and 200(2) and leaving open switches 104 of the horizontal grids of polarizers 200(1) and 200(2), right hand circular polarization may be achieved. Likewise, by leaving open switches 104 of the vertical grids of polarizers 200(1) and 200(2) and closing switches 104 of the horizontal grids of polarizers 200(1) and 200(2), left hand circular polarization may be achieved. Consequently, selectable circular polarization may be achieved and applied to a linearly polarized signal. Furthermore, if switches 104 for polarizers 200(1) and 200(2) are left open, linearly polarized signal 404 is left substantially unchanged and no left or right circular polarization is applied.

In accordance with an embodiment of the present invention, polarizers 102, 152, 200, 312, and 400 may be implemented with transistor switch grid (TSG) technology. For example, by utilizing the TSG technology, a dual polarizer may be constructed with switchable reflective or transmissive surface elements stacked in two (or more) contiguous layers. The dual polarizer would provide reflection of a vertically polarized signal and transmission of a horizontally polarized signal in one switched state or provide transmission of a vertically polarized signal and reflection of a horizontally polarized signal in another switched state (or, for example, provide selectable circular polarization as discussed herein).

The TSG technology, for example, may be implemented with switchable reflective/transmissive surfaces and controlled via low voltage complementary metal oxide semiconductor (CMOS) control circuitry, which may be encapsulated on a wafer utilizing glass or silicon-on-plastic technology. The silicon-on-plastic technology may be implemented, for example, using a polyimide circuit (e.g., 0.0005 inches thick) that is relatively rugged, flexible, and cost efficient, with the connectors for the control circuitry placed, for example, at the edges of the wafer. Further details regarding TSG technology may be found, for example, in U.S. Pat. No. 6,396,449, which is incorporated herein by reference in its entirety.

In accordance with an embodiment of the present invention, polarizers are disclosed for antenna applications. For example, a dual polarizer is disclosed for selectively rejecting vertically or horizontally polarized signals. The dual polarizer may include a first layer of surface elements having parallel rows of metal line segments connected by switches (e.g., transistors). The rows are spaced sufficiently apart to provide nearly total reflection of a vertically polarized signal when the switches are closed, but allow transmission of a horizontally polarized signal. The dual polarizer includes a second layer of surface elements having parallel rows of metal line segments connected by switches, with the rows orthogonal to the rows of the first layer. The rows of the second layer are spaced sufficiently apart to provide nearly total reflection of a horizontally polarized signal when the switches are closed, but allow transmission of a vertically polarized signal. When the switches are open for either layer, that layer allows the transmission of horizontally and vertically polarized signals. Consequently, by selectively closing the switches of the first layer and/or the second layer, vertically and/or horizontally polarized signals may be rejected.

The dual polarizer, in the above example, may be implemented to provide cross-polarization rejection, with minimal insertion loss to the desired polarized signal. For a radar system, the application of the dual polarizer may provide improved detection, identification, and profiling of targets (e.g., by reducing the level of cross-polarized signals in a dual polarization radar system). Because targets may be identified by their vertically and horizontally polarized return signals, the dual polarizer may also be utilized as a target discriminator by having dual polarization capability with acceptable cross-polarization rejection.

A conventional fixed grid of parallel wires on a low loss substrate placed in front of an antenna's radiating elements can mitigate the problem resulting from cross-polarized signals. However, communication systems (e.g., a radar system) may require a signal that can be selectively changed from a horizontal polarization to a vertical polarization. The conventional fixed wire grid would not permit transmission of one of the polarized signals. In contrast, in accordance with an embodiment of the present invention, polarizers are disclosed that permit the transmission and reception of horizontally and/or vertically polarized signals.

Furthermore, the dual polarizer may have its rows of line segments arranged for other signal applications. For example, rather than the rows of line segments configured to block or transmit a linearly polarized signal, the rows of line segments may be configured to provide circular polarization to a linearly polarized signal (e.g., right or left hand circular polarization). Additional applications, such as for elliptical polarization, would also fall within the scope of the present invention and be apparent to one skilled in the art based on the techniques disclosed herein.

Embodiments described above illustrate but do not limit the invention. It should also be understood that numerous modifications and variations are possible in accordance with the principles of the present invention. Accordingly, the scope of the invention is defined only by the following claims.

We claim:

1. An antenna system comprising:
an antenna adapted to receive or transmit electromagnetic signals;
a first plurality of line segments arranged in a first plane, wherein the electromagnetic signals pass through the first plurality of line segments traveling to or from the antenna; and
a first plurality of switches adapted to couple the first plurality of line segments into rows on the first plane when the first plurality of switches is closed.

2. The antenna system of claim 1, wherein the electromagnetic signals of a first polarization and a second polarization are rejected and transmitted, respectively, when the first plurality of switches are closed.

3. The antenna system of claim 1, wherein the antenna forms part of a communication system.

4. The antenna system of claim 1, further comprising:
a second plurality of line segments arranged in a second plane, wherein the electromagnetic signals pass through the second plurality of line segments traveling to or from the antenna; and
a second plurality of switches adapted to couple the second plurality of line segments into rows on the second plane when the plurality of switches is closed.

5. The antenna system of claim 4, wherein the rows on the second plane are orthogonal to the rows on the first plane.

6. The antenna system of claim 4, wherein the electromagnetic signals of a first polarization and a second polarization are rejected and transmitted, respectively, when the first plurality of switches are closed and the second plurality of switches are open, while the electromagnetic signals of the first polarization and the second polarization are transmitted and rejected, respectively, when the first plurality of switches are open and the second plurality of switches are closed.

7. The antenna system of claim 4, wherein the first and second plurality of line segments and the first and second plurality of switches form a first dual polarizer, the antenna further comprising a second dual polarizer arranged relative to the first dual polarizer to selectively transform a linearly polarized signal into a right hand circularly polarized signal or a left hand circularly polarized signal.

8. The antenna system of claim 7, wherein the linearly polarized signal becomes a right hand circularly polarized signal after passing through the first and second dual polarizers when the first plurality of switches are closed and the second plurality of switches are open, while the linearly polarized signal becomes a left hand circularly polarized signal after passing through the first and second dual polarizers when the first plurality of switches are open and the second plurality of switches are closed.

9. The antenna system of claim 7, wherein the antenna forms part of a communication system.

10. The antenna system of claim 4, wherein the first and second plurality of line segments and the first and second plurality of switches form a dual polarizer adapted to selectively block vertically or horizontally polarized signals of the electromagnetic signals.

11. The antenna system of claim 4, wherein the antenna forms part of a communication system.

12. The antenna system of claim 11, wherein the communication system comprises a radar system.

13. The antenna system of claim 4, wherein the first and second plurality of line segments and the first and second plurality of switches are implemented with transistor switch grid technology.

14. A system comprising:
an antenna;
a number of line segments arranged in a first and a second plane, which electromagnetic signals pass through when traveling to or from the antenna; and
a number of switches adapted to link the line segments to form a number of rows on the first and second plane.

15. The system of claim 14, wherein the first and second plane forms a dual polarizer, the dual polarizer rejecting vertically polarized signals when the switches on the first plane are closed and the switches on the second plane are open, and rejecting horizontally polarized signals when the switches on the second plane are closed and the switches on the first plane are open.

16. The system of claim 14, further comprising:
a number of line segments arranged in a third and a fourth plane, which electromagnetic signals pass through when traveling to or form the antenna; and
a number of switches adapted to link the line segments of the third and fourth plane to form a number of rows on the third and fourth plane, wherein a linearly polarized signal becomes a right hand circularly polarized signal when the switches on the first and third plane are closed and the switches on the second and fourth plane are open, and becomes a left hand circularly polarized signal when the switches on the first and third plane are open and the switches on the second and fourth plane are closed.

17. The system of claim 14, further comprising a processor adapted to control the switches on the first and second plane.

18. The system of claim 14, wherein the switches comprise transistors, PIN diodes, or micro-electromechanical system switches.

19. The system of claim 14, wherein the first and second plane are formed using transistor switch grid technology.

20. The system of claim 14, further comprising a spacer disposed between the first and second plane.

21. The system of claim 14, wherein the antenna is an electronically scanned antenna.

22. The system of claim 14, wherein the system is a communication system incorporated into a ground-based installation, a ship, an aircraft, or a spacecraft.

23. The system of claim 14, wherein the system is a radar system incorporated into a ground-based installation, a ship, an aircraft, or a spacecraft.

24. A method of selectively rejecting signals being received by or transmitted from an antenna, the method comprising:
connecting a first plurality of line segments to form a number of first rows to reflect signals having a first polarization while allowing signals to pass through having a second polarization; and
connecting a second plurality of line segments to form a number of second rows to reflect signals having the second polarization while allowing signals to pass through having the first polarization.

25. The method of claim 24, wherein the first and second plurality of line segments forms a dual polarizer, with the first rows orthogonal to the second rows.

26. The method of claim 24, further comprising controlling the connecting of the first and second plurality of line segments to provide cross-polarization rejection.

27. The method of claim 24, wherein the connecting of the first plurality of line segments or the connecting of the second plurality of line segments is selectively performed at any given time.

28. A method of providing circular polarization to a linearly polarized signal, the method comprising:
connecting a first plurality of line segments to form a number of first rows in a first and a second dual polarizer, wherein the linearly polarized signal is transformed into a right hand circularly polarized signal when the linearly polarized signal passes through the first and second dual polarizers; and
connecting a second plurality of line segments to form a number of second rows in the first and second dual polarizers, wherein the linearly polarized signal is transformed into a left hand circularly polarized signal when the linearly polarized signal passes through the first and second dual polarizers.

29. The method of claim 28, further comprising controlling the connecting of the first and second plurality of line segments in the first and second dual polarizers to provide selectively the right or left hand circularly polarized signal from the linearly polarized signal.

30. The method of claim 28, wherein the first and second dual polarizers are arranged at a 45 degree angle relative to the linearly polarized signal.

31. The method of claim 28, wherein the first plurality of line segments are parallel to each other and perpendicular to the second plurality of line segments.

32. The method of claim 28, wherein the connecting of the first plurality of line segments or the connecting of the second plurality of line segments is selectively performed at any given time.
